(19) United States
(12) Patent Application Publication
(10) Pub. No.: US 2009/0046839 A1
(43) Pub. Date: Feb. 19, 2009

(54) Verifying authenticity of called party in telephony networks

(75) Inventors: Stanley Taihai Chow, Ottawa (CA); Vinod Choyi, Ottawa (CA); Christophe Gustave, Ottawa (CA); Dmitri Vinokurov, Ottawa (CA)

Correspondence Address: GALASSO & ASSOCIATES, LP, P.O. BOX 26503, AUSTIN, TX, 78755-0503, US

(73) Assignee: ALCATEL LUCENT

(21) Appl. No.: 11/893,325

(22) Filed: Aug. 15, 2007

(51) Int. Cl. H04M 1/56

(52) U.S. Cl. 379/142.01

(57) ABSTRACT

A method comprising a plurality of operations. An operation is provided for receiving an authentication certificate of a called party. Telephony apparatus of a party calling the called party performs receiving the authentication certificate. An operation is provided for facilitating authentication of the authentication certificate and called party identification information thereof in response to receiving the authentication certificate. An operation is provided for providing an authentication notification in response to facilitating the authentication of the authentication certificate and the called party identification information. The authentication notification indicates successful authentication in response to the authentication being successful and wherein the authentication notification indicates non-successful authentication in response to the authentication not being successful.

### FIELD OF THE DISCLOSURE

The disclosures made herein relate generally to authentication provisions in telephony network systems and, more particularly, to verifying authenticity of called parties.

### BACKGROUND

Fraud related to identity theft schemes is becoming very prevalent in today's intricate telephony (e.g., voice/data) networks Malicious entities are taking advantage of well-established social behavior to gather sensitive information. Identity theft has also become a serious problem nearly everywhere in the world. For example, the United States Justice Department estimated in 2002 that up to 700,000 people in the United States were victimized by identity thieves, while more recent analyses place the estimates much higher.

These malicious entities leverage a false sense of security that telephony users have when it comes to phone systems, thereby tricking phone users into disclosing confidential information. Similar to a calling party attempting to obtain confidential information from the called party for the purpose of committing malicious acts (e.g., criminal and/or deceitful acts) with such confidential information, the situation also exists where a called party attempts to obtain confidential information from a called party for the purpose of committing malicious acts with such confidential information.

Accordingly, there are many scenarios where it is desirable for the calling party to authenticate the identity of a called party, even though the calling party controls the number called. One scenario is where the called number may have been wrongly associated to a 3^{rd} party entity, for example via an email phishing scam. Another scenario is where the called number may be a shared number in location such as, for example, a dormitory floor or room, a factory floor and the like. Another scenario is where the called number properly reaches a receptionist phone line of a receptionist who may not be trustworthy. Another scenario is where the called number properly reaches a corresponding home phone line, but a specific individual is the actual intended called party such as, for example, due to reasons of confidential information handling regulations (e.g., financial or medical information). Another scenario is where the called number is that of a cell phone that may or may not be in the immediate possession of the cell phone owner. Another scenario is where the called number may be unknown to a calling party (e.g., a number left on an answering machine of a phone number that the calling party has called). Another scenario is where the called number may have been accidentally or maliciously forwarded to another number. Another scenario is where, in high security contexts (e.g., military), there may be regulatory reasons to positively identify a called party.

Therefore, a solution that allows a calling party to authenticate the identity of a called party that has been reached would be advantageous, desirable and useful.

### SUMMARY OF THE DISCLOSURE

Embodiments of the present invention address the problem of a called party attempting to obtain confidential information from the calling party for the purpose of committing malicious acts with such confidential information. More specifically, embodiments of the present invention provide for authentication of identity information corresponding to a party with whom a calling party has reached (i.e., the called party). Through such authentication, a calling party can be reasonably assured that they are truly engaging in a telephony-based communication session (i.e., a telephone call) with an intended called party, thereby reducing the potential for unknowingly partaking in fraudulent or malicious activities.

In one embodiment of the present invention, a method comprising a plurality of operations. An operation is provided for receiving an authentication certificate of a called party. Telephony apparatus of a party calling the called party performs receiving the authentication certificate. An operation is provided for facilitating authentication of the authentication certificate and called party identification information thereof in response to receiving the authentication certificate. An operation is provided for providing an authentication notification in response to facilitating the authentication of the authentication certificate and the called party identification information. The authentication notification indicates successful authentication in response to the authentication being successful and the authentication notification indicates non-successful authentication in response to the authentication not being successful.

In another embodiment of the present invention, a server comprising various processor-executable instructions. Processor-executable instructions are provided for receiving an authentication certificate of a called party after initiating connection with telephony apparatus of the called party. Processor-executable instructions are provided for facilitating authentication of the authentication certificate and called party identification information thereof in response to receiving the authentication certificate. Processor-executable instructions are provided for providing an authentication notification in response to facilitating the authentication of the authentication certificate and the called party identification information. The authentication notification indicates successful authentication in response to the authentication being successful and the authentication notification indicates non-successful authentication in response to the authentication not being successful.

In another embodiment of the present invention, a telephony network system is configured to facilitate connection between telephony apparatus of a calling party and telephony apparatus of the called party, to conveying an authentication certificate of the called party to the calling party telephony apparatus in conjunction with facilitating the connection between the calling party telephony apparatus and the called party telephony apparatus, to facilitate authentication of the authentication certificate and called party identification information thereof in response to receiving the authentication certificate, and to provide an authentication notification in response to facilitating the authentication of the authentication certificate and the called party identification information. The authentication notification indicates successful authentication in response to the authentication being successful and the authentication notification indicates non-successful authentication in response to the authentication not being successful.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is a flow chart showing an embodiment of a method for facilitating called party authentication functionality in accordance with the present invention.

FIG. 2 is a schematic diagram of a registration infrastructure and process for information provider registration in accordance with the present invention.

FIG. 3 is a schematic diagram showing a first embodiment of an information identity authentication infrastructure and process performed by a user device executing an identification information authentication application in accordance with the present invention.

FIG. 4 is a schematic diagram showing a second embodiment of an information identity authentication infrastructure and process performed by a user device executing an identification information authentication application in accordance with the present invention.

FIG. 5 is a schematic diagram showing a third embodiment of an information identity authentication infrastructure and process performed by a user device executing an identification information authentication application in accordance with the present invention.

FIGS. 6a-6c are schematic diagrams of an information recipient device displaying identification information authentication messages in accordance with the present invention.

FIGS. 7a-7d are schematic diagrams of different methods of conveying called party authentication indications to calling party devices.

### DETAILED DESCRIPTION OF THE DRAWING FIGURES

The present invention provides a method for authenticating a phone user, thus thwarting threats related to spoofing of user identity. Specifically, the invention is directed to enabling a calling party to unambiguously and reliably identify a called party identity through an authentication notice delivered to his/her telephony apparatus on a per call basis. A registry holds authenticated identification information of the called party. The called party initially registers its identification information to the registry. Upon successful registration, the registry (operating as a certificate authority) signs the certificate embedded with the identification and the public key of the called party. Upon call set-up, the calling party uses a means such as, for example, an asymmetric key cryptographic function to authenticate the identity of the called party. Accordingly, the present invention provides real-time authentication of a called parties in telephony networks, thereby alleviating the burden for a user to query - either directly to the called party or through other out-of-band means—proof of identity of a party being called.

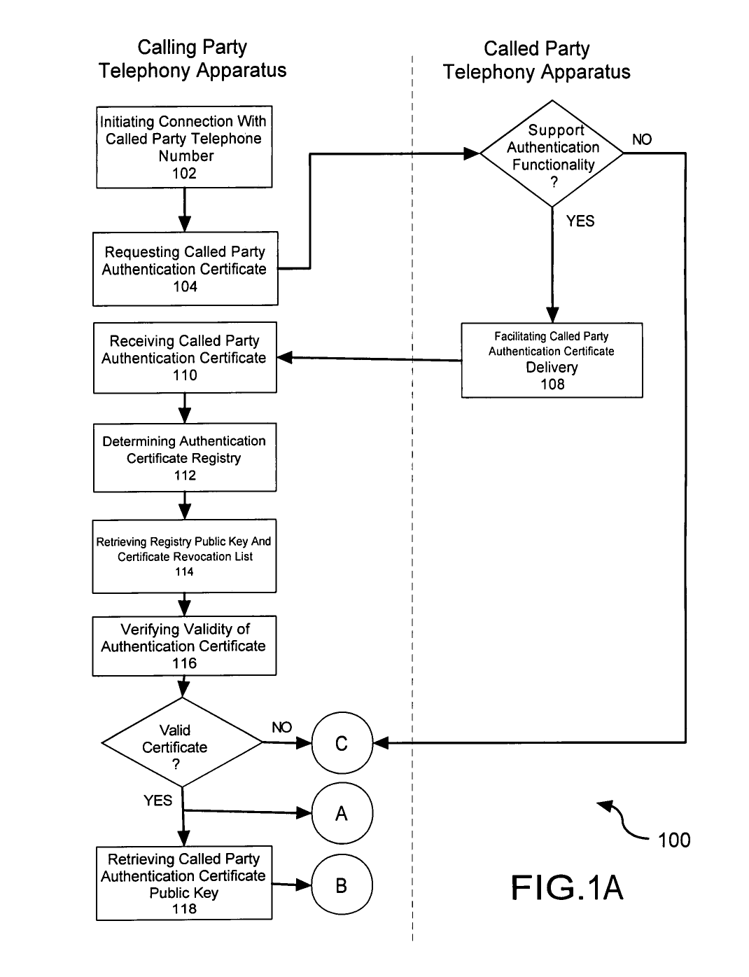

FIGS. 1A-1C show a method 100 for facilitating authentication and subsequent identification of a called party at call establishment time. Referring to FIG. 1A, an operation 102 is performed by a calling party telephony apparatus for initiating communication with a called party telephony apparatus for establishing connection with a called party telephone number. In response to initiating such communication, an operation 104 is performed for requesting a called party authentication certificate. In one embodiment, requesting the called party authentication triggers a respective component of authentication functionality in accordance with the present invention, which is provided for by the called party telephony apparatus. If the called party telephony apparatus does not support authentication functionality in accordance with the present invention, the calling party telephony apparatus performs an operation 106 for providing an authentication failure notification (i.e., an authentication failure notification), which indicates that the called party telephony apparatus does not support authentication functionality in accordance with the present invention. Examples of providing the authentication failure notification include, but are not limited to, an audible message and/or visual message indicating that the called party telephony apparatus does not support authentication functionality in accordance with the present invention. In addition to providing the authentication failure notification, it is disclosed herein that a pre-configured optional policy can dictate further action to be taken in the case of the called party telephony apparatus not supporting authentication functionality in accordance with the present invention (e.g. trigger an alarm function to appropriate network configuration management equipment). If the called party telephony apparatus does support authentication functionality in accordance with the present invention, an operation 108 is performed by the called party telephony apparatus for facilitating called party authentication certificate delivery. For example, in one embodiment, facilitating called party authentication certificate delivery includes accessing the called party authentication certificate and transmitting it for reception by the calling party telephony apparatus. In another embodiment, facilitating called party authentication certificate delivery includes instructing a remote system or apparatus to transmit the called party authentication certificate for reception by the calling party telephony apparatus. Accordingly, the present invention is not limited to any particular approach for facilitating delivery of the called party authentication certificate to the calling party telephony apparatus.

In response to the calling party telephony apparatus performing an operation 110 for receiving the called party authentication certificate, the calling party telephony apparatus performs an operation 112 for determining an authentication certificate registry that issued the called party authentication certificate, followed by performing an operation 114 for retrieving a registry public key and certificate revocation list therefrom. Using such retrieved information, the calling party telephony apparatus performs an operation 116 for verifying validity of the called party authentication certificate. For example, providing the called party authentication certificate is not on the retrieved certificate revocation list, verifying authenticity of the authentication certificate include using the registry public key to determine if the called party authentication certificate was signed by the private key of the authentication certificate registry. If it is determined that the authentication certificate is not authentic (e.g., was not signed by the registry's private key) or if the authentication certificate is on the certificate revocation list, expired, etc, the calling party telephony apparatus performs the operation 106 (or variant thereof) for providing an authentication failure notification (FIG. 1C). In addition to providing the authentication failure notification, it is disclosed herein that a pre-configured optional policy can dictate further action to be taken in the case of the authentication certificate not being successfully authenticated (e.g. trigger an alarm function to appropriate network security management equipment). If it is determined that the called party authentication certificate is authentic (e.g., was signed by the registry's private key) and the called party authentication certificate is not on the certificate revocation list, the calling party telephony apparatus performs the operation 118 for retrieving the public key from the called party authentication certificate and performs an operation 120 for requesting proof from the called party that the private key corresponding to the called party authentication certificate is in its possession (FIG. 1B). In response to requesting such proof, the called party telephony apparatus performs an operation 122 for responding to the request thereby causing such proof (i.e., alleged proof at this point) to be transmitted for reception by the calling party telephony apparatus. In response to such proof being sent, the calling party telephony apparatus performs an operation 124 for receiving the proof of private key possession. After receiving the proof of private key possession, the calling party telephony apparatus performs an operation 126 that verifies authenticity of such proof using the called party authentication certificate public key.

It is disclosed herein that the called party can be an individual or a group of individuals (e.g., a business entity). Thus, a response to the request for proof from the called party that the private key corresponding to the called party authentication certificate is in its possession can be from a specific individual or from one or more individuals authorized or capable of responding to such request. Furthermore, the response can be that of a system of the called party (e.g., a PBX of a business entity) or that of a telephone device (e.g., cell telephone) of the called party. In this manner, the response can be provided in an automated manner (e.g., by a device or system) or can be provided at the command of a person (e.g., in response to their entering a passcode that causes the required proof to be transmitted for reception by the calling party telephony apparatus).

The objective in requesting such proof is to verify that the private key corresponding to the called party authentication certificate is in possession of the called party. One embodiment of requesting such proof includes the calling party telephony apparatus generating a random number (i.e., a “nonce”) and transmitting the nonce for reception by the called party telephony apparatus. In response to receiving the nonce, the called party telephony apparatus encrypts the nonce with called party's private key (i.e., the private key corresponding to the called party authentication certificate) and transmits the encrypted nonce for reception by the calling party telephony apparatus. In response to receiving the encrypted nonce, the calling party telephony apparatus uses public key retrieved from the called party authentication certificate to decrypt the encrypted nonce. If the decrypted nonce is the same as that sent, it is assumed that the private key corresponding to the called party authentication certificate is in the possession of the called party (e.g., in possession of the called party telephony apparatus).

If it is determined that the provided proof of private key possession is not authentic (i.e., the proof provided does not indicate possession of the private key corresponding to the public key retrieved from the called party authentication certificate), the calling party telephony apparatus performs the operation 106 (or variant thereof) for providing an authentication failure notification. If it is determined that the provided proof of private key possession is authentic (i.e., the proof provided does indicate possession of the private key corresponding to the public key retrieved from the called party authentication certificate), the calling party telephony apparatus performs an operation 128 for accessing such presented identification information, followed by an operation 130 for verifying called party identification information presented by the called party against identification information retrieved from the called party authentication certificate after. For example, in conjunction with providing the proof of private key possession, identification information (e.g., a particular name of the called party) is also provided to the calling party telephony apparatus. If it is determined that the presented identification information matches the authenticated identification information, the calling party telephony apparatus performs an operation 132 for providing authentication information to the called party (e.g., via an audio message and/or a visual message), which acknowledges successful authentication of the called party. Otherwise, the calling party telephony apparatus performs the operation 106 for providing the authentication failure notification (e.g., indicating that the presented identification information does not match the authenticated identification information). In addition to providing the authentication failure notification, it is disclosed herein that a pre-configured optional policy can dictate further action to be taken in the case of the presented identification information not matching the authenticated identification information (e.g. trigger an alarm function to a network security management equipment).

As will now be discussed in greater detail, authentication of a called party in accordance with the present invention relies on an authenticated caller name registry. The caller name registry maybe maintained on a global level, regional level, local level or other level. The present invention is not limited to a particular range for which the registry covers. For the purposes of this disclosure, whenever an entity (e.g., called party) requires access to the called party authentication feature in a specific location area, that entity registers identification information with the local authority managing the registry of authenticated caller for this area or jurisdiction. Upon completion of the registration process, that entity is issued with an authentication certificate (e.g., X.509 certificate) having the identification information embedded therein and being signed by an authenticated caller name-recognized certificate authority. Phone endpoints associated with the entity are then provisioned with such authentication certificates on a per call basis to assert the authenticity of the provided caller name in a particular jurisdiction.

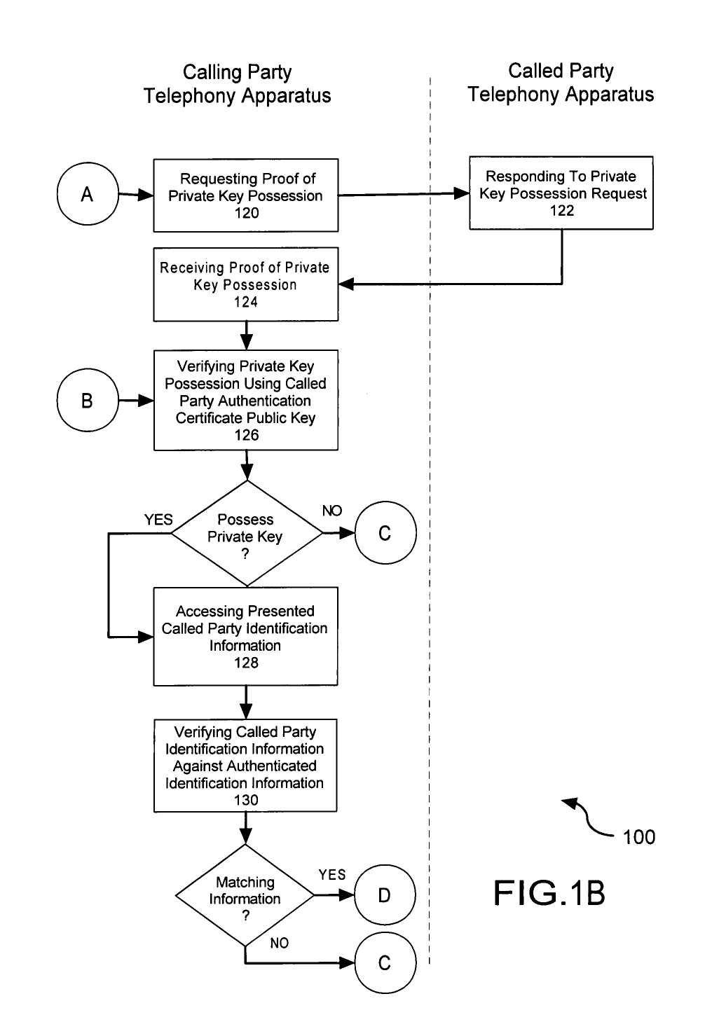

FIG. 2 is a schematic diagram of an exemplary registration infrastructure and associated process for registration of identification information in accordance with the present invention. In this example, a registrant 1110 (e.g., a called party) registers with three separate registries: registry 1101 is operated by a registration authority (RA) that is a network service provider 1100, registry 1201 is operated by a RA that is an interest group (such as a trade association), and registry 1301 is operated by a RA that is a geographical or political region (perhaps a government or other official entity). Registrant 1110 registers in this manner to provide authenticated identification information to information recipients that subscribe to any one of the available registries. That is, registrant 1110 can be authenticated to an information recipient if and only if the information recipient subscribes to one or more of the available registries, in this example, registries 1101, 1201 or 1301.

The respective RA operates each registry. Operating a registry is defined herein to include maintaining information contained in a registry. A RA may be any public or private organization interested in providing an identification information registry. A RA does not require approval from any authority to operate, but may seek endorsement by these authorities. End-users, service suppliers, and/or equipment suppliers can determine if any given registry is trustworthy, and subscribe to only those registries determined to be trustworthy. Each registry is composed of two main parts—the RA (Certification Authority in X.509 parlance) and a database of identification information. Each registry serves a predetermined subscriber group, region and/or a predefined interest group. A region served by one registry may overlap a region served by another registry, and two or more registries may serve the same region. Similarly, two or more different defined interest groups can overlap (e.g., doctors and the more narrowly defined interest group of pediatricians).

The registry 1101 is maintained by a network service provider 1100 that wishes to provide an authenticated information provider service to any company, public or government organization, or other registrant 1110 who wishes to provide authenticated identification information to information recipients served by the network service provider 1100. The registry 1201 is operated by the interest group 1200 such as, for example, the Canadian Bankers Association®, which maintains the registry 1201 to provide authenticated identification information and/or associated services to its bank members. The registry 1301 is associated with a geographical or political region such as, for example, New York State; the Province of Ontario; the City of Toronto; the greater Chicago area; etc. and is maintained by a corresponding government agency or other official entity 1300.

In one embodiment, the only responsibility borne by the RAs 1100, 1200 or 1300 is to ensure proof of identity of any registrant 1110 and to ensure that it does not register any duplicate identification information for different registrants 1110. In this embodiment, the registry 1101 (which consists of the database and the RA) can be freely inspected by the public and it is at least partially the responsibility of registrants 1110 and other interested parties to police the registries 1101, 1201 and 1301 in order to ensure that a confusingly similar or misleading information provider identity is not registered by another registrant 1110. When a registrant 1110 is registered, the RA issues an authentication certificate 1104. The authentication certificate certifies that the registered information provider identity (i.e., identification information) is bound to a public key of the registrant, which is in turn implicitly paired with a private key of the registrant.

It is disclosed herein that, depending on implementation/deployment choices, the authentication certificate of a registrant can be either embedded into a component of a telephony apparatus (e.g., telephone device, server, etc) or embedded in an authentication token (Smartcard, USB-based device, etc) pluggable into such component of a telephony apparatus.

### Registration Process

The authentication certificate 1104 provided to each registrant 1110 by a registry can conform to any known authentication system, and each registry can use a different authentication system without departing from the scope of the present invention. When the registrant's identification information is recorded in a registry, an authentication certificate is provided to the registrant 1110 to permit information provider authentication to be performed. The authentication certificate can be based on any public key infrastructure scheme like X.509.

If X.509 certificates are used for the authentication certificates provided to the registrants 1110, in one embodiment of the present invention, the registration process proceeds as follows (i.e., using RA 1100 as an example).

The RA 1100 publishes its public key in its root certificate. The root certificate is a certificate that has the public key of the Registry (i.e., Certification) Authority. This public key is used to verify authentication certificates, so the root certificate must be imported into each device that will perform the information provider authentication. Typically, it is assumed a vendor or owner of data communication equipment will pre-load the root certificates of interest—including any local regional registries, all popular trade and professional registries, etc. in much the same way that Web browsers are preloaded with PKI root certificates today. Optionally, there is a way for allowing the end user to import more root certificates in the cases where the end user does business in multiple regions or is interested in a specialized registry. As understood by those skilled in the art, there is no limit to how many root public keys can be imported or the means for allowing such import.

Each interested party (i.e., registry applicant) wishing to become a registrant 1110, generates its own public/private key pair, submits the public key to the RA 1100 along with its identification information and any other required registration information and/or documentation.

If the RA 1100 determines that the interested party in fact owns or is otherwise in lawful possession of the identification information, the RA 1100 enters the identification information into the database 1100 and uses the private key of RA 1100 to sign an authentication certificate that includes the registrant's identification information and the registrant's public key. The RA 1100 therefore “vouches” that the registrant's public key is “the” public key that is bound to the registrant's identification information, and that the registrant is entitled to use that identification information.

The registrant 1110 now has a signed authentication certificate that attests to its identification information, and the registrant 1110 also has the private key that permits the registrant 1110 to validate that authentication certificate. It should be understood that the meaning of the authentication certificate is limited. The authentication certificate only signifies that the holder of the private key (which should be registrant 1110) is entitled to have its identification information displayed in the jurisdiction of the particular registration authority 1100 with which the registrant 1110 has registered.

Accordingly, in at least one embodiment of the present invention, called party authentication functionality as disclosed herein relies upon registries descriptively referred to herein as “RealName registries” and associated authentication certificates (i.e., RealName certificates). Each RealName registry functions as a certificate authority for identification information. Examples of identification information in accordance with the present invention include, but are not limited to, a name by which an entity is recognized, an image specific to an entity, text specific to an entity, and a sound specific to an entity.

As depicted in FIG. 2, it is disclosed herein that RealName registries operate in effectively the same manner as trademarks registries. Each jurisdiction has its own trademarks registry, with possibly different rules for resolving ownership of a trademark and different rules for determining whether proposed identification information (e.g., a name) infringes an existing trademark. In fact, it is advantageous for RealName registries to be even more decentralized than trademark registries. For example, each jurisdiction can operate its own RealName registry, each profession can operate its own RealName registry, each trade association can operate its own RealName registry, etc. An information recipient (e.g., calling party) can pick and choose which registries they are willing to import. At a minimum, the information recipient will typically import RealName registries for the local jurisdiction and the profession that the information recipient deals with.

With the registries in place, authentication of a called party can proceed. Each registry operates as an issuer of “Certificate of approved name” as well as a database of “approved” identification information (i.e., generally referred to as RealNames). The certificates (i.e., authentication certificates) can be accomplished in many ways, but the simplest is the X.509 authentication certificates that are used for existing DNS/SSL. X.509 is a standardized public key infrastructure (PKI). In X.509 parlance, each registry operates as the “Certificate Authority” and each authentication certificate is essentially a package embedding the RealName and the public key. This package is then signed by the private key of the certificate authority. In operation, the authentication certificates are configured to include essentially any type of identification information useful for reinforcing an entity's identity.

### Called Party Authentication

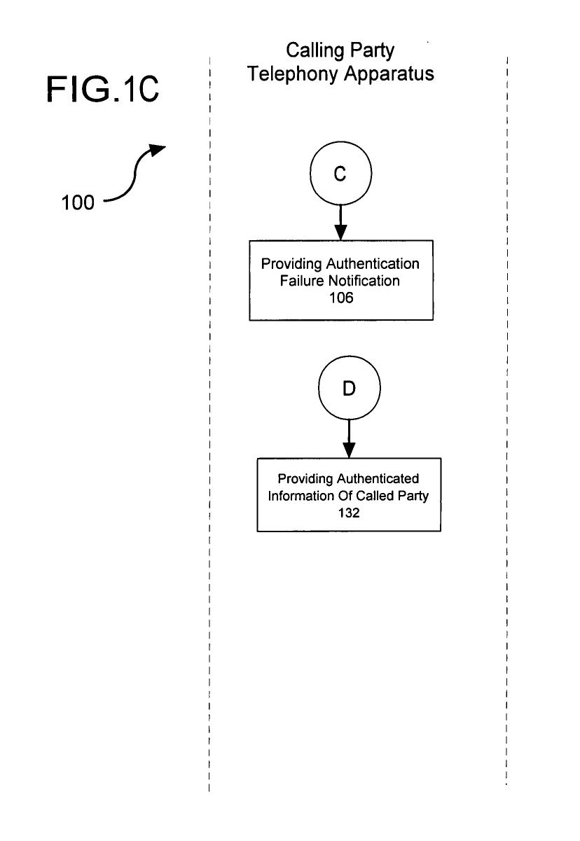

FIGS. 3-5 show embodiments of respective called party authentication systems in accordance with the present invention. Note that caller authentication does not require a query of the registries 1101,1201, 1301. In one embodiment, the caller presents its certificate to the called party, or a proxy for the called party, as will be explained below in more detail. In one embodiment, caller authentication is performed after call set-up. After the data/voice path is being established, the caller sends its certificate as part of a protocol to verify ownership of the private key corresponding to the certificate. An authentication dialog can be initiated by adding extensions to VoIP signalling protocol or by exchanging a special first signalling packet.

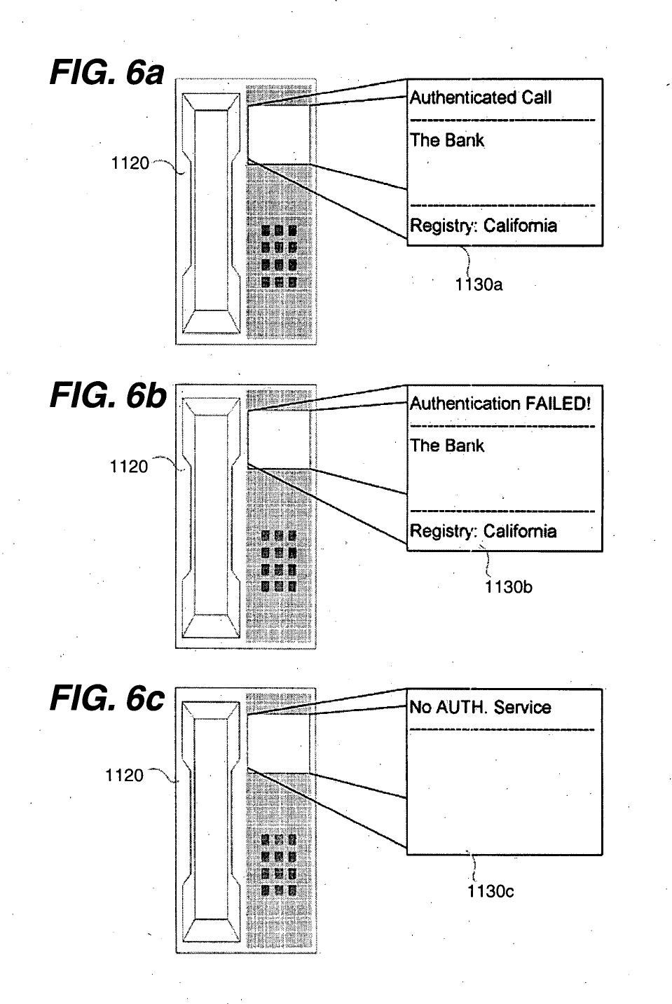

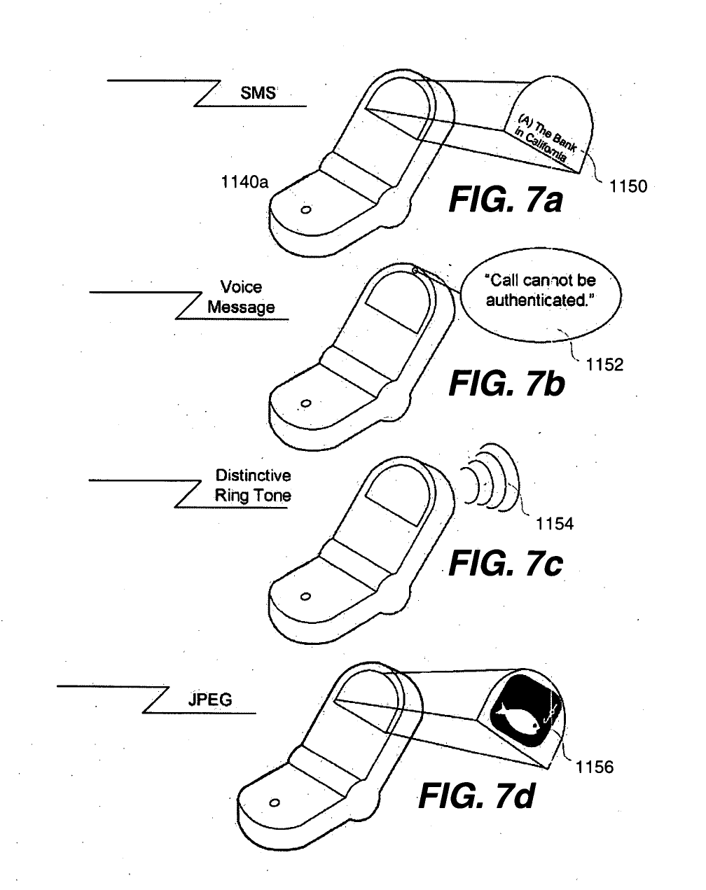

As shown in FIG. 3, in one embodiment of the present invention, the caller authentication is performed by the calling party telephony apparatus 1110, which is for example an Internet Protocol (IP) telephone. The IP telephone 1110 is equipped with a caller authentication application 1122. This is the most secure form of caller authentication because the called party directly controls it. When the calling party telephony apparatus 1110 initiates a call to the called party telephony apparatus 1120 (i.e., a registrant), call set-up (1a) proceeds through the telephone service provider network(s) in a manner well known in the art. The call set-up messages may carry regular caller information, but that information is ignored by the calling party telephony apparatus 1110 if a caller authentication dialogue (2a) is commenced when the called party telephony apparatus 1120 sends its authentication certificate, using one of the communications protocols referenced above. During such dialogue, the called party telephony apparatus 1120 provides required authentication information (e.g., certificate proof of private key possess, identification information, etc) to the calling party telephony apparatus 1110. The caller authentication application 1122 conducts the authentication dialogue with the called party telephony apparatus 1120, facilitates authentication of the called party authentication certificate, facilitates proof of the called party possessing the private key corresponding to the called party authentication certificate, and, optionally, that presented identification information matches authenticated identification information. Upon successfully authentication and verification, authenticated identification information (e.g., an authenticated caller name) is then provided (3a) via the calling party telephony apparatus 1110, as will be explained below with reference to FIG. 6a-6c and 7a-7d.

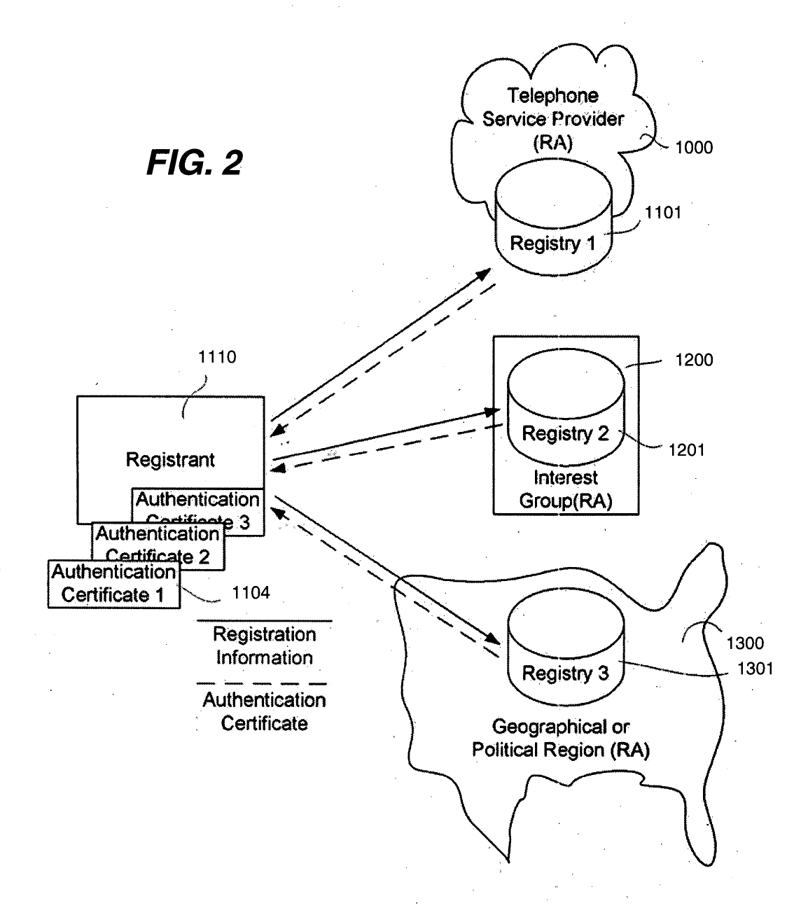

As shown in FIG. 4, in accordance with another embodiment of the present invention, the caller authentication is performed by a public branch exchange, such as an Internet Protocol Public Branch Exchange (IP-PBX) 1116 which serves as a proxy for called parties connected to an enterprise network 1118. In this embodiment, call set-up (1b) proceeds by conventional means through one or more networks, in this example a broadband carrier network 1114. During or after call set-up, the calling party telephony apparatus 1110 initiates a called party authentication dialogue (2b) with called party telephony apparatus 1120. During such dialogue, the called party telephony apparatus 1120 provides required authentication information (e.g., certificate proof of private key possess, identification information, etc) to the calling party telephony apparatus 1110. The called party authentication application 1122 facilitates authentication of the called party authentication certificate, facilitates proof of the called party possessing the private key corresponding to the called party authentication certificate, and, optionally, that presented identification information matches authenticated identification information. Upon successfully authentication and verification, authenticated identification information (e.g., an authenticated caller name) is then provided (3a) via the calling party telephony apparatus 1110, as will be explained below with reference to FIG. 6a-6c and 7a-7d.

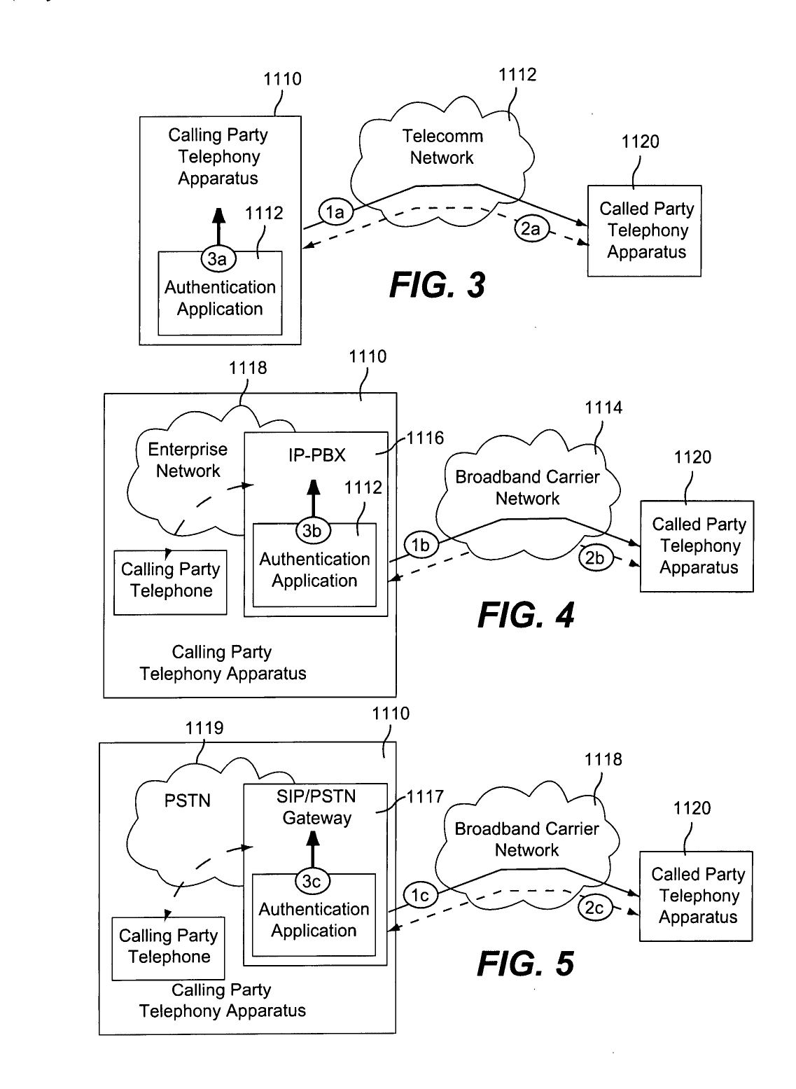

As shown in FIG. 5, in accordance with another embodiment of the present invention, the called party authentication is performed by a network gateway 1117, such as a Session Initiation Protocol (SIP)/Public Switched Telephone Network (PSTN) gateway that serves as a proxy for called parties connected to a Public Switched Telephone Network (PSTN) 1119. In this embodiment, call set-up (1c) proceeds by conventional means through the SIP/PSTN gateway 1117 and one or more networks, in this example the broadband carrier network 1114 to the called party telephony apparatus 1120. During or after call set-up, the calling party telephony apparatus 1110 initiates a called party authentication dialogue (2c) with the called party telephony apparatus 1120. During such dialogue, the called party telephony apparatus 1120 provides required authentication information (e.g., certificate proof of private key possess, identification information, etc) to the calling party telephony apparatus 1110. The called party authentication application 1122 facilitates authentication of the called party authentication certificate, facilitates proof of the called party possessing the private key corresponding to the called party authentication certificate, and, optionally, that presented identification information matches authenticated identification information. Upon successfully authentication and verification, authenticated identification information (e.g., an authenticated caller name) is then provided (3a) via the calling party telephony apparatus 1110, as will be explained below with reference to FIG. 6a-6c and 7a-7d.

FIGS. 6a-6c show examples of authentication messages conveyed to a calling party in accordance with one embodiment of the invention. In these examples, the authentication messages displayed indicate whether the called party information has been authenticated; the called party name (optionally the logo, etc.); and the registry 1101, 1201, 1301 with which the called party has registered.

FIG. 6a shows an exemplary display format 1130a for authenticated called party information. A first line of the display 1130a indicates that the called party name has been successfully authenticated. A second line of the display 1130a displays the authenticated called party name. The last line of the display displays the name of the RA, in this example a registry associated with the State of California.

FIG. 6b shows an exemplary display format 1130b for a called party that could not be authenticated because authentication failed. As understood by those skilled in the art, called party authentication may fail for any one of a number of reasons. For example: the caller may present a stolen authentication certificate for which the called party does not have the corresponding private key; the authentication certificate cannot be validated with the public key of the CA; a communications failure may have occurred; an authentication dialogue may have been interrupted; etc. A first line of the display 1130b indicates that the called party has not been successfully authenticated because called party authentication has failed. A second line of the display 1130b displays the called party name contained in the certificate, if available. The last line of the display 1130c displays the name of the registry contained in the certificate, if available. To further highlight the fact that authentication failed, the message can be displayed in a bright color, red for example, etc.

FIG. 6c shows an exemplary display format 1130c for a called party that could not be authenticated because the called party did not present a certificate. The first line of the display 1130c indicates that the called party has not attempted authentication and the rest of the lines may be blank, as shown, or may display a called party name and/or number extracted from the call set-up signalling messages, in which case the fact that authentication was not attempted should be emphasized by highlighting or blinking the no authentication service message.

As will be understood by those skilled in the art, the display formats 1130a-1130c may not always be practical or desired by a calling party. It is therefore contemplated that other forms of call authentication indications may be conveyed to a calling party. FIGS. 7a-7d illustrate alternate ways to convey an indication of authenticated identification information (i.e., called party name) to a calling party. Although the examples shown in FIGS. 7a-7d illustrate a specific type of user device (cellular telephone) it should be understood that such indications could be conveyed to most known types of telephone devices.

As shown in FIG. 7a, a message indication successful or non-successful authentication can be conveyed to a calling party using an out-of-band message sent concurrently with or after a ringing signal is sent to the user device. In this example, a Short Message Service (SMS) message is sent. The SMS message includes an indication 1150 that the called party has been authenticated (A), or not authenticated (NA), which is not shown; and, the called party identification information, in this example, “The Bank in California”.

As shown in FIG. 7b, alternatively an in-band voice message can be played to the calling party to indicate whether the called party could be authenticated. The in-band voice message can be played to the calling party after the called party answers, but before the call is “cut through”, so that the called party cannot forge the message. In this example, the calling party receives a voice message 1152 indicating that the called party could not be authenticated.

As shown in FIG. 7c, in a further alternative a distinctive ring tone is sent to the calling party device. One ring tone 1154 indicates an authenticated called party and another ring tone (not shown) indicates an unauthenticated called party.

As shown in FIG. 7d, in yet a further alternative an image, for example a .jpeg image is sent to the calling party device to indicate whether the called party has been authenticated. In this example, a .jpeg image 1156 indicates that the called party could not be authenticated. Another .jpeg image (not shown) is used to indicate that the called party has been authenticated.

Referring now to processor-executable instructions in accordance with the present invention, it will be understood from the disclosures made herein that methods, processes and/or operations configured for facilitating called party authentication functionality as disclosed herein are tangibly embodied by computer readable medium having instructions thereon that are configured for carrying out such functionality. In one specific embodiment, the instructions are tangibly embodied for carrying out one or more of the methodologies disclosed in reference to FIGS. 1-7. The instructions may be accessible by one or more data processing devices from a memory apparatus (e.g. RAM, ROM, virtual memory, hard drive memory, etc), from an apparatus readable by a drive unit of a data processing system (e.g., a diskette, a compact disk, a tape cartridge, etc) or both. Accordingly, embodiments of computer readable medium in accordance with the present invention include a compact disk, a hard drive, RAM or other type of storage apparatus that has imaged thereon instructions (e.g., a computer program) adapted for facilitating called party authentication functionality in accordance with the present invention.

A call authentication system in accordance with the present invention can be embodied in any number of configurations. In one embodiment, such a call authentication system is a server including processor-executable instructions for carrying out at least a portion of called party authentication functionality in accordance with the present invention. In another embodiment, such a called party authentication system includes a dedicated telephone device having processor-executable instructions for carrying out at least a portion of called party authentication functionality in accordance with the present invention.

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A method, comprising:
receiving an authentication certificate of a called party, wherein said receiving is performed by telephony apparatus of a party calling the called party;
facilitating authentication of the authentication certificate and called party identification information thereof in response to receiving the authentication certificate; and
providing an authentication notification in response to facilitating said authentication of the authentication certificate and said called party identification information, wherein the authentication notification indicates successful authentication in response to said authentication being successful and wherein the authentication notification indicates non-successful authentication in response to said authentication not being successful.

2. The method of claim 1, further comprising:
requesting the authenticating certificate, wherein receiving the authentication certificate is performed after said requesting.

3. The method of claim 1 wherein facilitating authentication of the authentication certificate includes:
verifying validity of the authentication certificate; and
verifying that the called party is in possession of a private key corresponding to a private key of the authentication certificate.

4. The method of claim 3, further comprising:
verifying called party identification information presented by the called party against called party identification information of the authentication certificate.

5. The method of claim 3 wherein verifying that the called party is in possession of a private key corresponding to a private key of the authentication certificate includes:
requesting proof from the called party that the called party is in possession of a private key corresponding to a private key of the authentication certificate; and
receiving said proof in response to requesting said proof.

6. The method of claim 5, further comprising:
verifying called party identification information presented by the called party against called party identification information of the authentication certificate.

7. The method of claim 5 wherein providing the authentication notification includes displaying called party identification information of the authentication certificate after successfully verifying that the called party is in possession of a private key corresponding to a private key of the authentication certificate.

8. A server, comprising:
processor-executable instructions for receiving an authentication certificate of a called party after initiating connection with telephony apparatus of the called party;
processor-executable instructions for facilitating authentication of the authentication certificate and called party identification information thereof in response to receiving the authentication certificate;
processor-executable instructions for providing an authentication notification in response to facilitating said authentication of the authentication certificate and said called party identification information, wherein the authentication notification indicates successful authentication in response to said authentication being successful and wherein the authentication notification indicates non-successful authentication in response to said authentication not being successful.

9. The server of claim 8, further comprising:
processor-executable instructions for requesting the authenticating certificate, wherein receiving the authentication certificate is performed after said requesting.

10. The server of claim 8 wherein facilitating authentication of the authentication certificate includes:
verifying validity of the authentication certificate; and
verifying that the called party is in possession of a private key corresponding to a private key of the authentication certificate.

11. The server of claim 10, further comprising:
processor-executable instructions for verifying called party identification information presented by the called party against called party identification information of the authentication certificate.

12. The server of claim 10 wherein verifying that the called party is in possession of a private key corresponding to a private key of the authentication certificate includes:
requesting proof from the called party that the called party is in possession of a private key corresponding to a private key of the authentication certificate; and
receiving said proof in response to requesting said proof.

13. The server of claim 12, further comprising:
processor-executable instructions for verifying called party identification information presented by the called party against called party identification information of the authentication certificate.

14. The server of claim 12 wherein providing the authentication notification includes displaying called party identification information of the authentication certificate after successfully verifying that the called party is in possession of a private key corresponding to a private key of the authentication certificate.

15. A telephony network system configured to: i.) facilitate connection between telephony apparatus of a calling party and telephony apparatus of the called party, ii.) conveying an authentication certificate of the called party to said calling party telephony apparatus in conjunction with facilitating said connection between said calling party telephony apparatus and said called party telephony apparatus, iii.) facilitate authentication of the authentication certificate and called party identification information thereof in response to receiving the authentication certificate, and iv.) provide an authentication notification in response to facilitating said authentication of the authentication certificate and said called party identification information, wherein the authentication notification indicates successful authentication in response to said authentication being successful and wherein the authentication notification indicates non-successful authentication in response to said authentication not being successful.

16. The system of claim 15 further configured to request the authenticating certificate, wherein receiving the authentication certificate is performed after the authenticating certificate is requested.

17. The system of claim 15 wherein being configured to facilitate authentication of the authentication certificate includes:
being configured to verify validity of the authentication certificate; and
being configured to verify that the called party is in possession of a private key corresponding to a private key of the authentication certificate.

18. The system of claim 17 further configured to verify called party identification information presented by the called party against called party identification information of the authentication certificate.

19. The system of claim 17 wherein being configured to verify that the called party is in possession of a private key corresponding to a private key of the authentication certificate includes:
being configured to request proof from the called party that the called party is in possession of a private key corresponding to a private key of the authentication certificate; and
being configured to receive said proof in response to requesting said proof.
